(19) United States
(12) Patent Application Publication
(10) Pub. No.: US 2013/0295520 A1
(43) Pub. Date: Nov. 7, 2013

(54) FULL-VOLTAGE DENTAL WATER JET

(71) Applicant: Hsin Te Hsieh, Tainan City (TW)

(72) Inventor: Hsin Te Hsieh, Tainan City (TW)

(21) Appl. No.: 13/462,195

(22) Filed: May 2, 2012

(51) Int. Cl. A61C 17/02

(52) U.S. Cl. 433/89

(57) ABSTRACT

A full-voltage dental water jet of the invention includes a base, a pump, a suspension stand, a reservoir and a microcomputer control system. The base has a lower case and an upper case. The pump disposed in the lower case has an inlet and an outlet. The suspension stand having at least three engaging portions, a heat dissipating aluminum plate, a first standing portion and a second standing portion is disposed between the pump and the lower case. The reservoir is disposed above the base. The microcomputer control system is disposed in the upper case. The microcomputer control system has the function of adapting the dental water jet to the universal input voltage. In addition, the suspension stand made of the silica gel material reduces the operation noise and the vibration of the pump.

### BACKGROUND OF THE INVENTION

(1) Field of the Invention

The invention relates to a full-voltage dental water jet, and more particularly to a dental water jet having a base and a microcomputer control system, which has a voltage input judging unit and is disposed in the base, wherein the voltage input judging unit adapts the dental water jet to the universal input voltage (AC 100V to 240V). In addition, a suspension stand made of a silica gel material is disposed between a lower case of the base and a pump to reduce the operation noise of the pump and isolate the base from the vibration of the pump.

(2) Description of the Prior Art

The multitudes only pay attention to the oral health in caring the tooth whitening and whether the tooth is decayed, but completely ignore the importance of the gingival health. In fact, the gum and the teeth have the same importance because the gum may naturally atrophy when the person reaches a predetermined age. When the tooth brushing method is incorrect, the tartar cannot be removed, and the atrophy of the gum is speeded up to cause the loose tooth and the problem of the dental maintenance. If the mouth has all the whitened teeth but has no healthy gum, the mouth may be like a beautiful building without the foundation.

Thus, the associated teeth medical manufacturers elaborately design family dental water jets capable of removing the dirt with the high water pressure and massaging the gum in a pulsating manner. Thus, the dental water jets can be used at home every day, so that the tooth cleaning, the oral hygiene and the gingival health can be really achieved.

### SUMMARY OF THE INVENTION

The invention provides a full-voltage dental water jet, which comprises:

a base having a lower case and an upper case, wherein the lower case has an opening facing upwards, at least three fixing stands, heat dissipating openings and a support stand having a horizontal through hole are disposed on a bottom surface of the lower case, the upper case has an opening facing downwards and is connected to and fit with the lower case, two opposite plate fixing slots and a full-voltage power socket are disposed on an inner wall of the upper case, a valve slot and a depression are disposed on a top surface of the upper case, the top surface of the upper case has at least one hole, into which a bottom end of a jet tip may be inserted, and a conduit is connected to the jet tip and the through hole of the lower case;

a pump, which is a water driving element comprising an inlet and an outlet and is disposed in the lower case of the base, wherein the inlet is linked to a turning portion and connected to the valve slot of the upper case, and the outlet passes through the through hole of the support stand;

a suspension stand, which comprises at least three engaging portions, a heat dissipating aluminum plate, a first standing portion and a second standing portion, and is disposed between the pump and the bottom surface of the lower case, wherein the at least three engaging portions are connected to the at least three fixing stands of the lower case, respectively, such that the suspension stand is fixed to the lower case, the heat dissipating aluminum plate is correspondingly disposed above the heat dissipating opening of the lower case, and the first standing portion and the second standing portion have a first through hole and a second through hole, through which the inlet and the outlet of the pump pass, respectively;

a reservoir, which is a water storage having an opening facing upwards and is disposed above the base, wherein a control valve and a projection are disposed on a bottom surface of the reservoir and correspond to the valve slot and the depression of the upper case, respectively; and

a microcomputer control system assembled into the two plate fixing slots on the inner wall of the upper case.

The suspension stand is integrally formed by a silica gel material.

The microcomputer control system comprises a central processing unit, a voltage input judging unit, a memory, a voltage transformer unit, a key unit, a power indicator unit and an electric power output unit. The central processing unit has one end or multiple ends for receiving encoding instructions, executing the instructions and outputting signals. The voltage input judging unit judges a current entering the full-voltage power socket. The memory is an electronically erasable read-only memory (EEROM) capable of saving data as a final mode so that the data is not lost when an electric power is interrupted. The voltage transformer unit transforms an AC current into a DC current. The key unit is disposed on the top surface of the upper case of the base and has power switching and mode switching functions. The power indicator unit is disposed on a corner portion of the top surface of the upper case of the base, and the electric power output unit provides the electric power to the pump for operation.

The full-voltage dental water jet of the invention has the following advantages.

First, the microcomputer control system with the voltage input judging unit is disposed in the base of the invention, wherein the voltage input judging unit makes the dental water jet be adapted to the universal input voltage (AC 100V to AC 240V), and the dental water jet can be used all over the world without a voltage transformer.

Second, the voltage input judging unit of the microcomputer control system of the invention has the automatic voltage detecting function, so that the dental water jet is free from the problem of connecting to the incorrect voltage source and the security in use is extremely high.

Third, the pump in the base of the invention is connected to the suspension stand made of the silica gel material, and the suspension stand reduces the operation noise of the pump and isolates the base from the vibration of the operating pump.

Fourth, the full-voltage dental water jet of the invention has the light and handy model, and has the total weight of about 530 g, which is advantageous to the user who wants to carry the water jet outside for journey or business.

Fifth, when the full-voltage dental water jet of the invention is retracted, the base can be skillfully stored into the reservoir so that the overall size of the water jet is reduced. When the base is fit with the reservoir, the conduit, the jet tip and the like can be separated from the base, so that the storage space can be optimized.

Sixth, the key unit of the microcomputer control system of the invention has four output modes. The water output amount of the jet tip may be adjusted through the key unit, and the user may find the proper water pressure mode to massage the gum and clean the teeth by pressing or touching the key unit.

Seventh, the electric power output unit of the microcomputer control system of the dental water jet of the invention has the security protection function, and the electric power output unit can automatically shut down the power once the pump for driving the water is overheated.

Eighth, the water storage amount of the reservoir of the dental water jet of the invention is about 500 cubic centimeters, so the large-capacity water storage can store the water amount for the user to clean the teeth once without repeatedly adding water.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorial view showing a dental water jet of the invention.

FIG. 2 is an exploded view showing a reservoir and a base of the dental water jet of the invention.

FIG. 3 is one decomposed exploded view showing a lower case and an upper case of the base of the dental water jet of the invention.

FIG. 4 is another decomposed exploded view showing the lower case and the upper case of the base of the dental water jet of the invention.

FIG. 5 is an exploded view showing a pump, a suspension stand and the lower case of the base of the dental water jet of the invention.

FIG. 6 is a block diagram showing a microcomputer control system disposed inside the base of the invention.

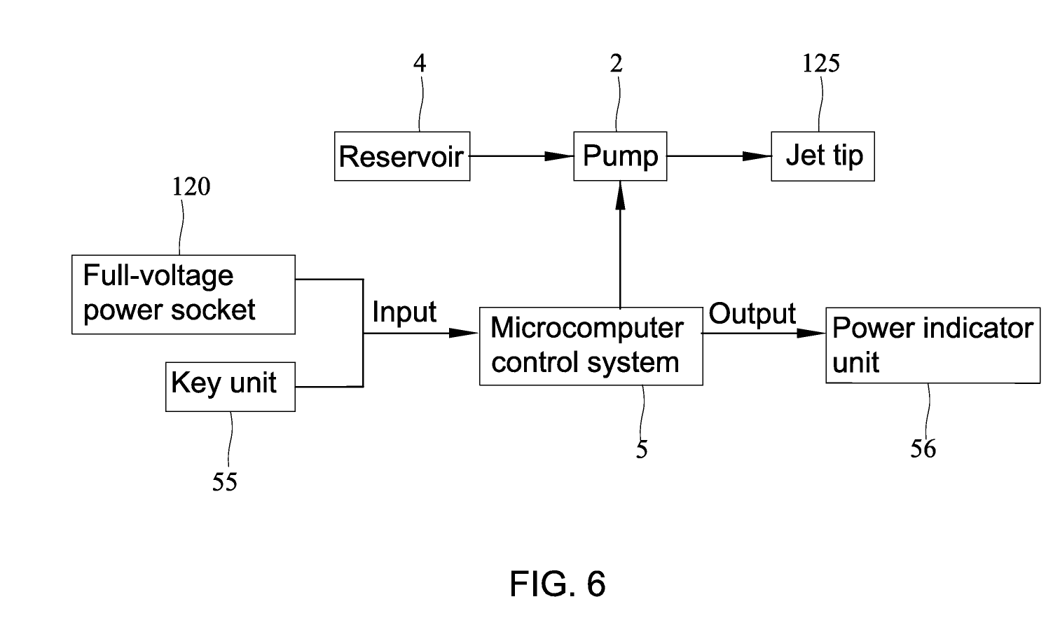

FIG. 7 is a circuit diagram showing a microcomputer control system of the invention.

### DETAILED DESCRIPTION OF THE PREFERRED EMBODIMENTS

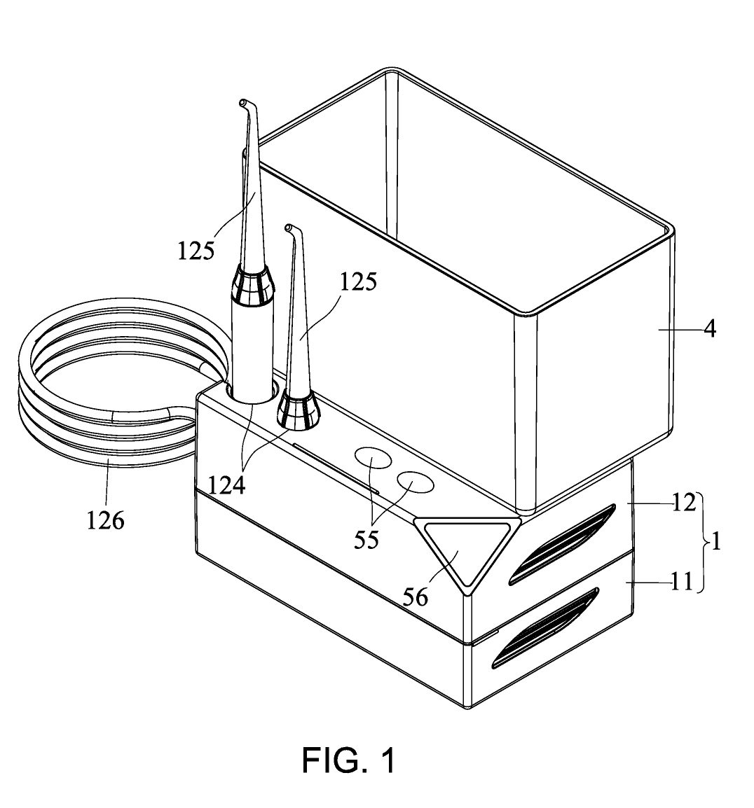

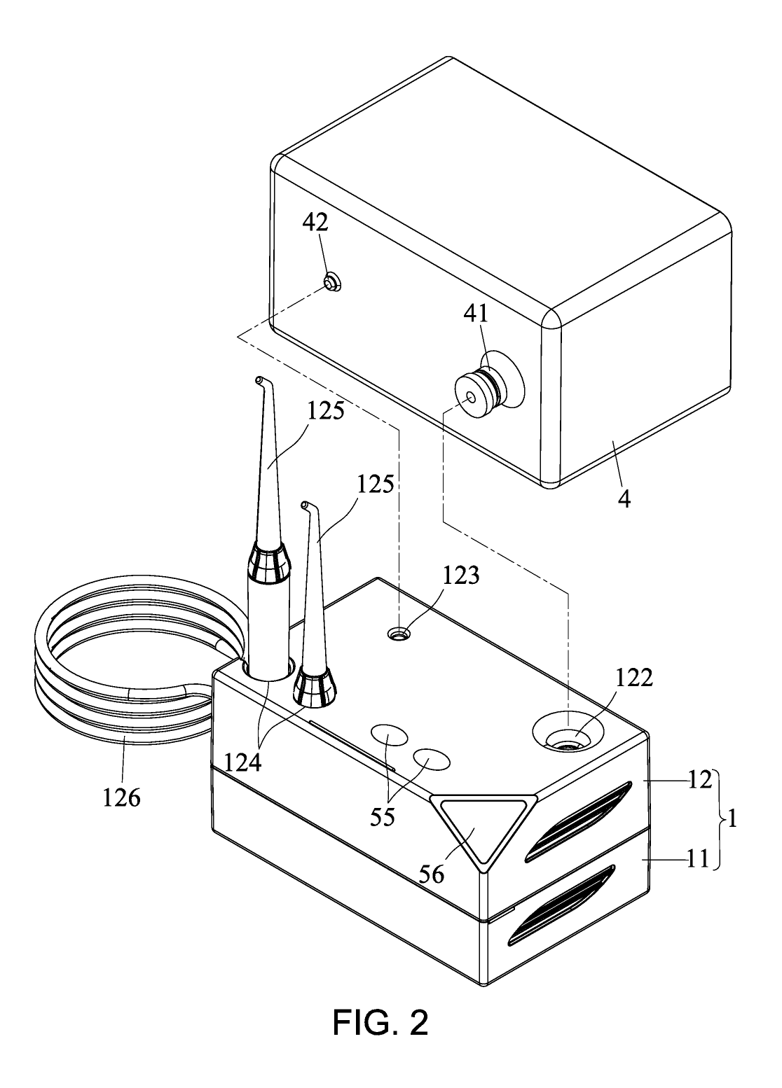

Referring to FIGS. 1 and 2, the full-voltage dental water jet of the invention includes a base (1), a pump (2), a suspension stand (3), a reservoir (4) and a microcomputer control system (5).

The base (1) has a lower case (11) and an upper case (12). The lower case (11) has an opening facing upwards. At least three fixing stands (111), heat dissipating openings (112) and a support stand (114) having a horizontal through hole (113) are disposed on a bottom surface of the lower case (11). The upper case (12) has an opening facing downwards and is connected to and fit with the lower case (11). Two opposite plate fixing slots (121) and a full-voltage power socket (120) are disposed on an inner wall of the upper case (12). A valve slot (122) and a depression (123) are formed on a top surface of the upper case (12). In addition, the top surface of the upper case has at least one hole (124), into which a bottom end of a jet tip (125) can be inserted. A conduit (126) is connected to the jet tip (125) and the through hole (113) of the lower case (11).

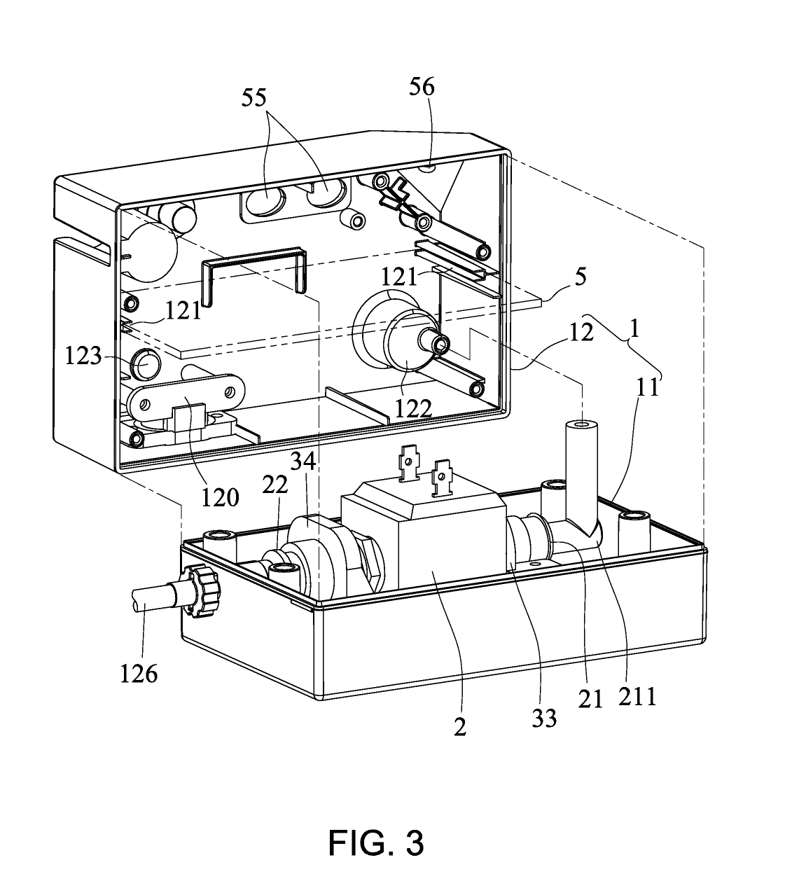

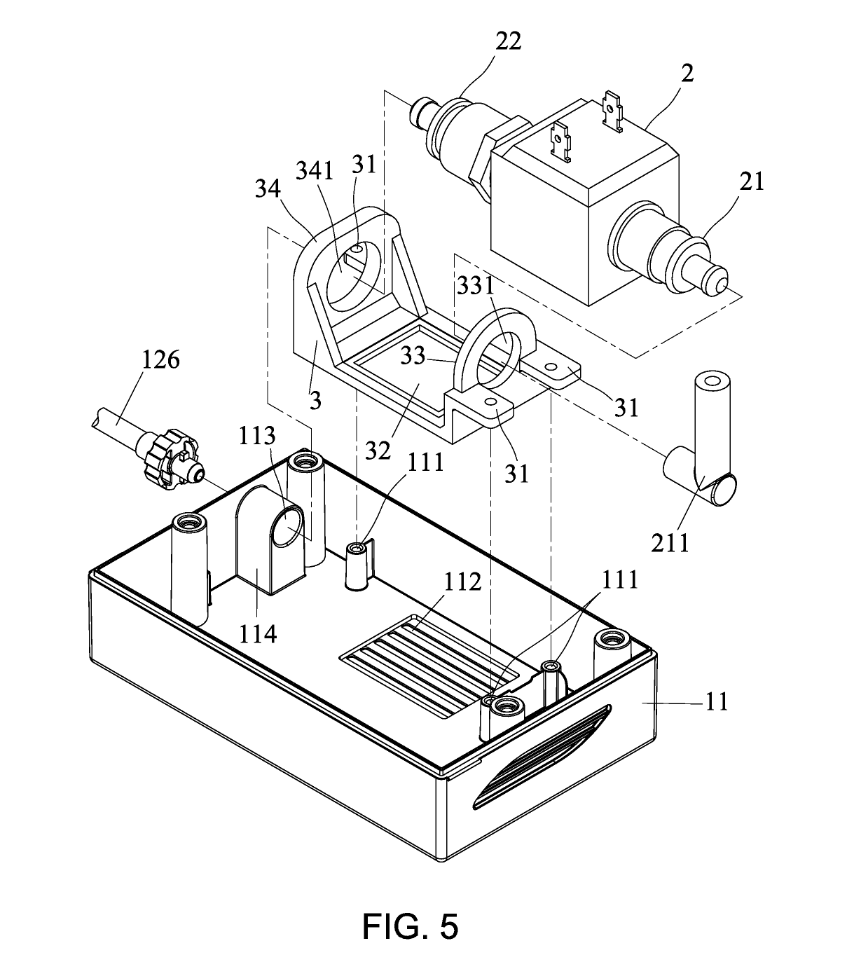

The pump (2) is a water driving element (see FIGS. 3 to 5) including an inlet (21) and an outlet (22) and is disposed in the lower case (11) of the base (1). The inlet (21) is linked to a turning portion (211) and is connected to the valve slot (122) of the upper case (12), and the outlet (22) passes through the through hole (113) of the support stand (114). The suspension stand (3) includes at least three engaging portions (31), a heat dissipating aluminum plate (32), a first standing portion (33) and a second standing portion (34), as shown in FIGS. 3 to 5, and is disposed between the pump (2) and the bottom surface of the lower case (11). The engaging portions (31) are correspondingly connected to the fixing stands (111) of the lower case (11), respectively, such that the suspension stand (3) is fixed to the lower case (11). The heat dissipating aluminum plate (32) is correspondingly disposed above the heat dissipating openings (112) of the lower case (11). The first standing portion (33) and the second standing portion (34) respectively have a first through hole (331) and a second through hole (341), through which the inlet (21) and the outlet (22) of the pump (2) pass, respectively.

The reservoir (4) is a water storage having an opening facing upwards and is disposed above the base (1). A control valve (41) and a projection (42) (see FIG. 2) are disposed on a bottom surface of the reservoir (4) and correspond to the valve slot (122) and the depression (123) of the upper case (12).

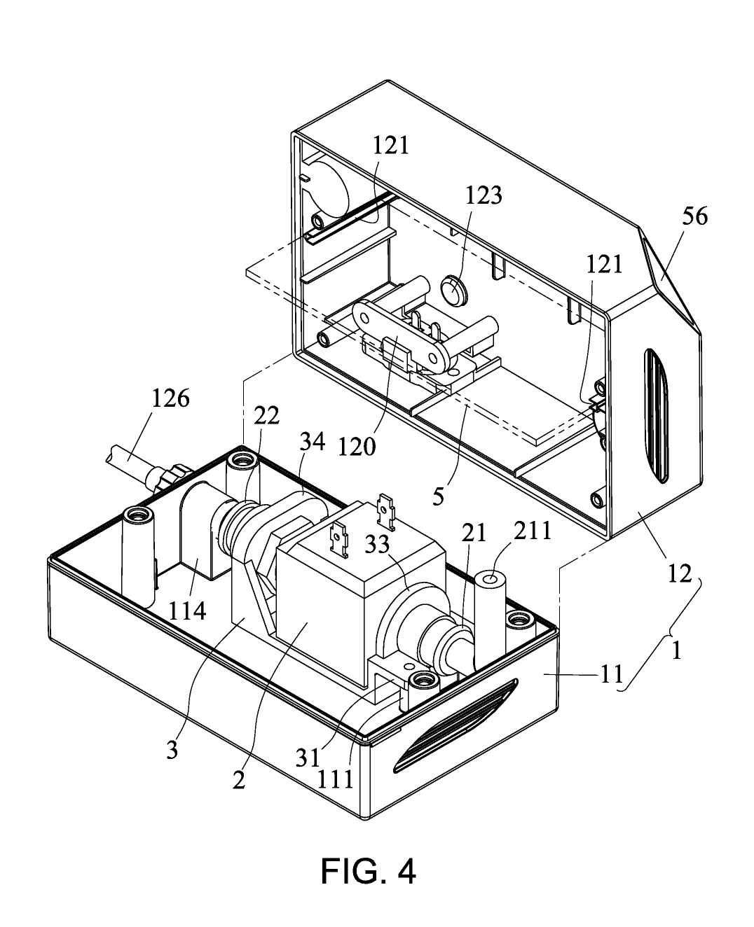

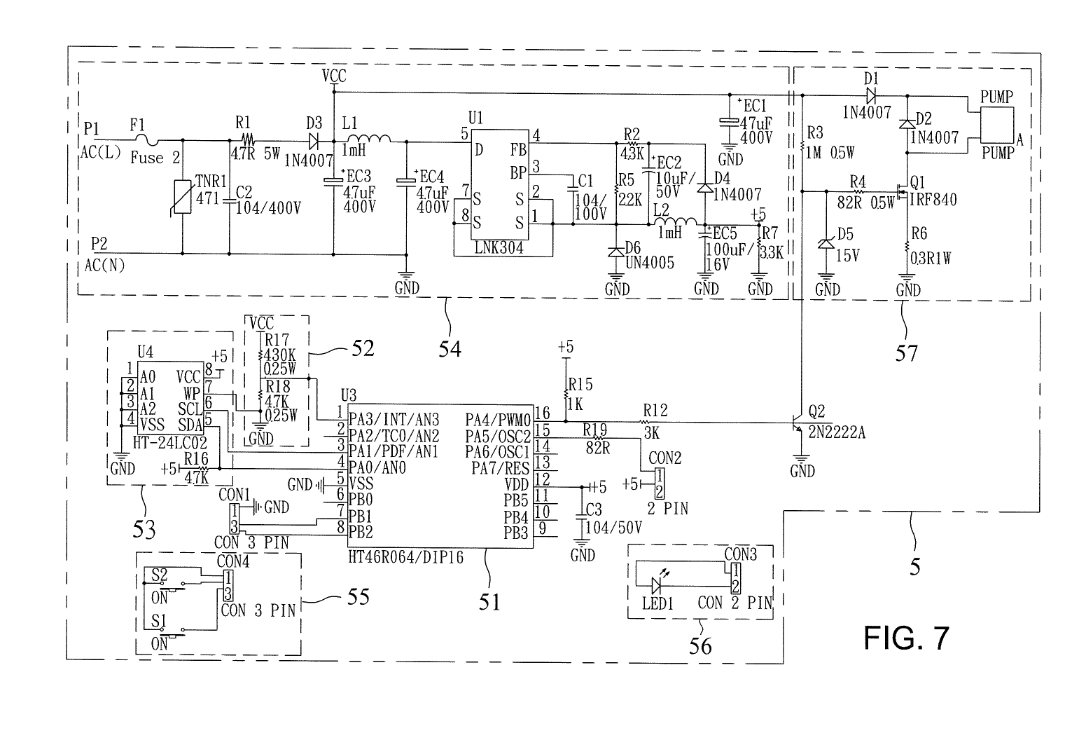

The microcomputer control system (5) includes a central processing unit (51), a voltage input judging unit (52), a memory (53), a voltage transformer unit (54), a key unit (55), a power indicator unit (56) and an electric power output unit (57), as shown in FIG. 7. The microcomputer control system (5) is assembled into the two plate fixing slots (121) of the upper case (12), as shown in FIGS. 3 and 4. The central processing unit (51) may have one end or multiple ends for receiving encoding instructions, executing the instructions and outputting signals. The voltage input judging unit (52) may judge a current entering the full-voltage power socket (120). The memory (53) is an electronically erasable read-only memory (EEROM) capable of saving data as the final use mode so that the data is not lost when the electric power is interrupted. The voltage transformer unit (54) may transform the AC current into the DC current. The key unit (55) is disposed on the top surface of the upper case (12) of the base (1) and has power switching and mode switching functions. The power indicator unit (56) is disposed on a corner portion of the top surface of the upper case (12) of the base (1). The electric power output unit (57) may provide the electric power to the pump (2) for operation.

The members of the invention may be assembled according to the following steps. First, the inlet (21) and the outlet (22) of the pump (2) pass through the first through hole (331) of the first standing portion (33) of the suspension stand (3) and the second through hole (341) of the second standing portion (34) of the suspension stand (3). Next, the engaging portions (31) of the suspension stand (3) are correspondingly connected to the fixing stands (111) inside the lower case (11) of the base (1), respectively, so that the suspension stand (3), the pump (2) and the lower case (11) are connected and fixed together. Meanwhile, the outlet (22) of the pump (2) passes through the horizontal through hole (113) of the support stand (114) of the lower case (11), and the inlet (21) of the pump (2) is connected to the turning portion (211) after passing through the first through hole (331). Then, the microcomputer control system (5) is assembled into the two plate fixing slots (121) of the upper case (12) of the base (1), and the upper case (12) covers over the lower case (11), so that the valve slot (122) of the upper case (12) is appropriately connected to the turning portion (211) of the inlet (21) of the pump (2). Finally, the conduit (126) is linked to the bottom end of the jet tip (125) and the outer end of the horizontal through hole (113) of the lower case (11) so that the members of the invention are completely assembled.

When the full-voltage dental water jet of the invention is used, the key unit (55) of the microcomputer control system (5) has the power switching and mode switching functions, so that the power is turned on when the user touches the key unit (55), and the key unit (55) has five output modes. The water output amount of the jet tip (125) may be adjusted through the key unit (55), and the user may find the proper water pressure mode to massage the gum and clean the teeth by pressing or touching the key unit.

When the full-voltage dental water jet of the invention is used, the voltage input judging unit (52) of the microcomputer control system (5) inside the base (1) can judge that the current entering the full-voltage power socket (120) is caused by which kind of voltage, and the voltage transformer unit (54) transforms the introduced current into the voltage adapted to the dental water jet, so that the dental water jet is adapted to the universal input voltage (AC 100V to AC 240V), and the dental water jet of the invention may be used all over the world without a voltage transformer.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A full-voltage dental water jet, comprising:
a base having a lower case and an upper case, wherein the lower case has an opening facing upwards, at least three fixing stands, heat dissipating openings and a support stand having a horizontal through hole are disposed on a bottom surface of the lower case, the upper case has an opening facing downwards and is connected to and fit with the lower case, two opposite plate fixing slots and a full-voltage power socket are disposed on an inner wall of the upper case, a valve slot and a depression are formed on a top surface of the upper case, the top surface of the upper case has at least one hole, into which a bottom end of a jet tip may be inserted, and a conduit is connected to the jet tip and the through hole of the lower case;
a pump, which is a water driving element comprising an inlet and an outlet and is disposed in the lower case of the base, wherein the inlet is linked to a turning portion and connected to the valve slot of the upper case, and the outlet passes through the through hole of the support stand;
a suspension stand, which comprises at least three engaging portions, a heat dissipating aluminum plate, a first standing portion and a second standing portion, and is disposed between the pump and the bottom surface of the lower case, wherein the at least three engaging portions are connected to the at least three fixing stands of the lower case, respectively, such that the suspension stand is fixed to the lower case, the heat dissipating aluminum plate is correspondingly disposed above the heat dissipating opening of the lower case, and the first standing portion and the second standing portion have a first through hole and a second through hole, through which the inlet and the outlet of the pump pass, respectively;
a reservoir, which is a water storage having an opening facing upwards and is disposed above the base, wherein a control valve and a projection are disposed on a bottom surface of the reservoir and correspond to the valve slot and the depression of the upper case, respectively; and
a microcomputer control system assembled into the two plate fixing slots on the inner wall of the upper case.

2. The dental water jet according to claim 1, wherein the suspension stand is integrally formed by a silica gel material.

3. The dental water jet according to claim 1, wherein the microcomputer control system comprises a central processing unit, a voltage input judging unit, a memory, a voltage transformer unit, a key unit, a power indicator unit and an electric power output unit, the central processing unit has one end or multiple ends for receiving encoding instructions, executing the instructions and outputting signals, the voltage input judging unit judges a current entering the full-voltage power socket, the memory is an electronically erasable read-only memory (EEROM) capable of saving data as a final mode so that the data is not lost when an electric power is interrupted, the voltage transformer unit transforms an AC current into a DC current, the key unit is disposed on the top surface of the upper case of the base and has power switching and mode switching functions, the power indicator unit is disposed on a corner portion of the top surface of the upper case of the base, and the electric power output unit provides the electric power to the pump for operation.
